(19) United States
(12) Patent Application Publication
(10) Pub. No.: US 2006/0088449 A1
(43) Pub. Date: Apr. 27, 2006

(54) Systems and methods for transferring a fluid sample

(75) Inventors: Todd Thorsen, Arlington, MA (US); Mats Cooper, Boston, MA (US)

Correspondence Address: FISH & NEAVE IP GROUP;ROPES & GRAY LLP, ONE INTERNATIONAL PLACE, BOSTON, MA, 02110-2624, US

(73) Assignee: MASSACHUSETTS INSTITUTE OF TECHNOLOGY, Cambridge, MA (US)

(21) Appl. No.: 11/259,446

(22) Filed: Oct. 26, 2005

Related U.S. Application Data
(60) Provisional application No. 60/622,523, filed on Oct. 26, 2004.

(51) Int. Cl. B01L 3/00

(52) U.S. Cl. 422/100

(57) ABSTRACT

Devices having channels where one end of the channel has a dead-end formed of a gas permeable, but fluid resistant material (e.g., material that is substantially liquid impermeable) are provided. The devices can be manufactured using methods employing photolithography techniques similar to those used in semi-conductor manufacture. In other aspects, methods are provided for transferring a sample such that fluid can be drawn to the dead-end of a fluid channel by injecting, adding, or otherwise placing a sample at one end of the channel and by applying pressure, such as negative pressure via a vacuum, to the gas permeable material via another channel or port that is spaced apart from the dead-end containing fluid channel. Application of a positive or negative pressure to another recess in the gas permeable housing that is spaced away from the fluid channel causes a pressure change within the fluid channel, thereby drawing fluid across the channel to the dead-end of the channel.

### CROSS-REFERENCE TO OTHER PATENT APPLICATIONS

This application claims priority to U.S. provisional application 60/622,523, filed Oct. 26 2004, the content of which is incorporated herein by reference in its entirety.

### BACKGROUND OF THE INVENTION

Today, microarray technologies allow scientists to perform thousands of biological experiments simultaneously. To perform these microarray tests, scientists typically purchase microarrays from a commercial supplier. The microarrays supplied by the commercial vendor comprise a plastic or glass substrate that had affixed to the surface of the substrate a plurality of nucleic acid-based or amino acid-based probes.

Although these commercially available systems work quite well, they are expensive to manufacture. This cost can be prohibitive for many researchers. Accordingly, there is a need in the art for devices that are simpler to manufacture and use, and therefore less costly to produce than standard commercially available microarray devices.

However, even among researchers for whom price is not a factor, the standard microarray approach has other more fundamental limitations that curtail the broader use of these technologies, especially in clinical settings. Microarray technologies have been built on the premise that higher density arrays are better because they yield more information. However, higher density arrays are only better if they yield reliable information and if, after subtracting away any unreliable information, the higher density array still yields more information than lower density approaches. Furthermore, more information is only better if it is the type of information most useful to a particular researcher. In many settings, the important question is not which of 10,000 genes are expressed in one sample, but rather, how does expression of several specific genes compare across many different samples.

Current microarray technology is based on macrofluidic principles. Specifically, regardless of the size and density of the array, analysis of a sample takes place one sample at a time (e.g., analysis of the sample versus the array) and processing of a sample requires hybridization and washing steps that occur across the entire array. Current array technology seems to fail to make use of the microfluidics which would allow analysis of multiple samples simultaneously across the sample array. The use of microfluidics can significantly increase the information available from a particular experiment, as well as decrease the costs associated with such work.

The above example of microarrays is just exemplary of the classic problem of how to efficiently and reliably transfer small samples along distinct paths. This problem transcends the boundaries of biology, chemistry, and other disciplines.

Despite the tremendous advances in the fields of fluids and microarray technologies, significant limitations remain and these limitations prevent the full and complete application of these technologies to problems in biology, chemistry, and other disciplines. Accordingly, there is a need in the art for improved methods and devices to transfer small volumes of sample, and the invention provides such methods and devices.

### SUMMARY OF THE INVENTION

The invention provides systems and methods for transferring samples. In one aspect, the invention describes devices having channels where one end of the channel has a dead-end formed of a gas permeable, but fluid resistant material (e.g., material that is substantially liquid impermeable). The devices of the invention can be manufactured using methods employing photolithography techniques similar to those used in semi-conductor manufacture. In other aspects, the invention provides methods for transferring a sample such that fluid can be drawn to the dead-end of a fluid channel by injecting, adding, or otherwise placing a sample at one end of the channel and by applying pressure, such as negative pressure via a vacuum, to the gas permeable material via another channel or port that is spaced apart from the dead-end containing fluid channel. Application of a positive or negative pressure to another recess in the gas permeable housing that is spaced away from the fluid channel causes a pressure change within the fluid channel, thereby drawing fluid across the channel to the dead-end of the channel.

More particularly, in one aspect, the systems and methods described herein include systems for transferring a sample. The system may comprise a substrate component and a gas permeable element being impermeable to the sample and arranged with the substrate component to define a fluid channel with a dead-end at an end of the fluid channel.

In one embodiment of such systems the gas permeable element may comprise a gas permeable housing having patterns etched onto one surface, to define the fluid channel and the dead-end. The gas permeable housing may be placed in opposition to the substrate component and may further comprise a fastener to affix the substrate component to the gas permeable housing. The gas permeable housing may further comprise an input port, which intersects the fluid channel and may have an input landing for loading a sample. Additionally and optionally, a vacuum port and a vacuum channel may be located within the gas permeable housing, and spaced away from the fluid channel, for applying a pressure to the interior of the fluid channel.

The fluid channel may comprise an extended channel having the gas permeable element disposed therein to define the fluid channel and a vacuum channel. Optionally, at least one gas permeable housing wall of a fluid channel may be coated with a gas impermeable material. The gas permeable element may be substantially liquid impermeable and may comprise an essentially non-reactive elastomeric material selected from the group consisting of poly-di-methyl-siloxane (PDMS), polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), or polytetrafluoroethylene (Teflon).

The substrate component may have at least one of nucleic acids, gold electrodes and proteins attached to a surface and may include one of a slide, microtiter plate, microarray a glass element, silica element and plastic element and a hybridization membrane. The sample may include at least one of a liquid, gas, hydrophilic substances, hydrophobic substances, nucleic acids, proteins and blood. Optionally, the substrate component may comprise a substrate having at least one channel etched onto a surface of the substrate.

In another embodiment, the substrate component may comprise a fluid passage extending at least partially through the substrate component and the gas permeable element may be disposed in the fluid passage to form a gas permeable dead-end. Additionally and optionally, a gasket layer may be placed in between the housing and the substrate along at least one fluid channel to form an airtight seal.

In another aspect, the systems and methods described herein include a method for transferring a sample. The method may include the steps of providing a system comprising a substrate component, a fluid channel and a gas permeable element which is impermeable to the sample and forms at least one dead-end. The system may additionally comprise an input port, which may intersect the fluid channel, an input landing for loading the sample and a vacuum port spaced away from the fluid channel for applying a pressure to the interior of the fluid channel. The sample is added to the input landing of the system and pressure is applied to the interior of the fluid channel through the vacuum port. Following the application of pressure at the vacuum port, the sample is transferred to the dead-end of the fluid channel.

In such methods, the applied pressure may include negative pressure and positive pressure. The sample may be at least one of liquid and gas and may comprise at least one of hydrophilic substances, hydrophobic substances, nucleic acids, proteins, blood.

### BRIEF DESCRIPTION OF THE DRAWINGS

The following figures depict certain illustrative embodiments of the invention in which like reference numerals refer to like elements. These depicted embodiments may not be drawn to scale and are to be understood as illustrative of the invention and not as limiting in any way.

FIG. 1 is a three dimensional view of the assembly of one embodiment of the invention comprising a gas permeable housing, a substrate, fluid channels, vacuum channels and input ports.

FIG. 2 is a three dimensional view of the assembly of another embodiment of the invention comprising a gas permeable housing, a substrate, a vacuum channel, fluid channels, input ports and vacuum ports.

FIG. 3 depicts a cross-sectional view of one embodiment of the invention shown in FIG. 2.

FIGS. 4A-4D depict a technique for simultaneously analyzing multiple samples using one embodiment of the invention.

FIG. 5 is a bottom view of a gas permeable housing for a device having a plurality of non-uniform and non-intersecting etched channels.

### DETAILED DESCRIPTION

These and other aspects and embodiments of the systems and methods of the invention will be described more fully by referring to the figures provided.

The systems and methods described herein will now be described with reference to certain illustrative embodiments, although the invention is not to be limited to these illustrated embodiments which are provided merely for the purpose of describing the systems and methods of the invention and are not to be understood as limiting in any way. The invention provides devices and methods for transferring fluids. The invention is based, at least in part, on the observation that air trapped within micro-channels interferes with the efficient transfer of samples through these channels. The systems and methods provide a solution to this problem involving the use of fluid channels containing at least one dead-end, and the use of pressure applied to the fluid channel via a separate channel or port that is located within the same device but spaced away from the fluid channel. Application of pressure to the fluid channel causes a pressure change within the fluid channel, thereby removing the trapped air and drawing fluid across the channel to the dead-end of the channel.

In one aspect, the invention describes devices having channels where one end of the channel has a dead-end formed of a gas permeable, but fluid resistant material (e.g., material that is substantially liquid impermeable). The devices of the invention can be manufactured using methods employing photolithography techniques similar to those used in semi-conductor manufacture. In other aspects, the invention provides methods for transferring a sample such that fluid can be drawn to the dead-end of a fluid channel by injecting, adding, or otherwise placing a sample at one end of the channel and by applying pressure, such as negative pressure via a vacuum, to the gas permeable material via another channel or port that is spaced apart from the dead-end containing fluid channel. Application of a positive or negative pressure to another recess in the gas permeable housing that is spaced away from the fluid channel causes a pressure change within the fluid channel, thereby drawing fluid across the channel to the dead-end of the channel.

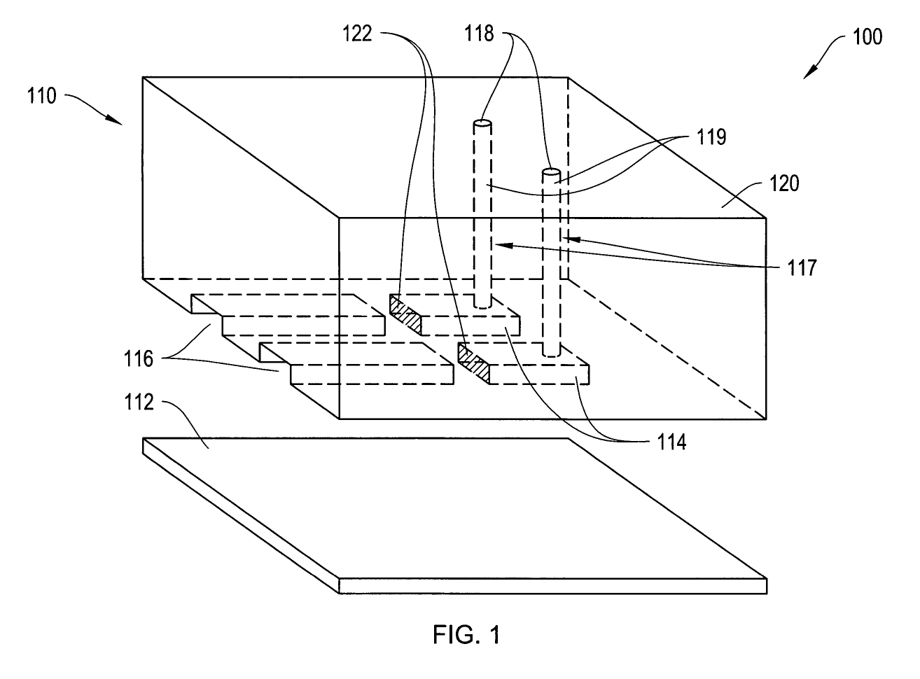

FIG. 1 depicts a first embodiment of the device described herein, and in particular depicts a three-dimensional view of a device 100 to transfer fluids including a gas permeable housing 110 attached to a substrate 112. The gas permeable housing 110 is formed from a gas permeable material 120 that is etched on one surface to form fluid channels 114 and vacuum channels 116. A sample is introduced through the input ports 117 in the gas permeable housing 110. The input ports 117 comprise an input well 119 and an input opening 118. One end of a fluid channel that is closer to a vacuum channel forms the gas permeable dead-end 122.

Device 100 shown in FIG. 1 can be used to transfer a sample. By way of example, a sample can be added to the input port 117 by injecting, pipetting, or otherwise adding sample at the input opening 118. Depending on the characteristics and volume of the particular sample, some amount of the sample might ordinarily be expected to flow through the input port and toward the fluid channel. However, this flow is unpredictable and uncontrollable, and reliance on this fluid flow alone would be inefficient and difficult to reliably reproduce across multiple samples. Accordingly, to efficiently transfer a substantial amount of the sample from the input opening 118 to the fluid channel 114, pressure is applied, for example, via the vacuum channel 116. The amount of pressure, as well as whether the pressure is negative or positive pressure, can be readily determined based on the characteristics of the sample. Application of pressure via the vacuum channel 116, by attaching a pressure source directly to the vacuum channel 116, results in a pressure change in the vacuum channel 116, as well as a pressure change in the interior of the fluid channel 114. This pressure change in the fluid channel 114 transfers the sample through the input port 117 and through the corresponding fluid channel 114 that intersects the input port 117. In one example, the sample is transferred to the dead-end 122 of the fluid channel 114.

In certain illustrated embodiments, the gas permeable housing 110 is placed in opposition to a substrate 112. Such substrates 112 include microarrays, slides and filters. In such embodiments, the substrate 112 is placed beneath the housing 110 such that a surface of the substrate contacts the bottom surface of the gas permeable housing 110. In FIG. 1, the bottom surface of the gas permeable housing 110 refers to the surface of the housing 110 with which the fluid channels 114 are contiguous. In other words, the fluid channels 114 are open when viewed from the bottom surface of the housing 110, and thus when a substrate 112 is disposed beneath the bottom surface of the gas permeable housing 110, the surface of the substrate 112 forms a surface of the fluid channel 114 and will be in contact with any fluid passing through the fluid channel 114. Thus the fluid channel 114 would be contiguous with the surface of the substrate 112. In the embodiment in FIG. 1, the channels through which fluid flows is defined by the channels etched into the lower surface of the housing 110 and the upper surface of the substrate 112. In alternative embodiments, the channel may be a through-hole that extends through housing 110. Other technologies for forming the fluid channel may also be employed.

As shown in FIG. 1, the gas permeable housing 110 is made of a suitable elastomeric material. Suitable elastomeric materials are typically substantially liquid impermeable. In other words, fluid can be passed through channels that are close to but spaced apart from one another without mixing between the fluid samples. Furthermore, suitable elastomeric materials are typically non-reactive. Non-reactive elastomeric materials do not react, or only minimally react, biochemically with a sample. This biochemical non-reactivity is distinguishable from adherence that may occur between certain samples and certain elastomeric materials due, for example, to electrostatic interactions. In certain embodiments, the elastomeric material can be coated with one or more agents. Exemplary agents such as Teflon help decrease adherence between the elastomeric material and the sample. In certain embodiments, all or a portion (e.g., only a fluid channel 114 and/or input port 117) of the gas permeable housing 110 can be coated with one or more agents designed to promote the stability of the sample. Exemplary agents include, but are not limited to, RNase inhibitors to prevent degradation of RNA samples; DNase inhibitors to prevent degradation of DNA samples, protease inhibitors to prevent degradation of protein samples; anti-microbial agents to prevent microbial infections that can degrade any biological sample; and anti-fungal agents to prevent fungal infections that can degrade any biological sample. For any of the foregoing examples involving the coating of the gas permeable housing 110 with one or more agents, the systems may include embodiments in which the agents are added to the elastomeric material and incorporated within the elastomeric material during the fabrication process, as well as embodiments in which the housings are coated with agents post-fabrication.

Exemplary elastomeric materials include, but are not limited to, polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), polytetrafluoroethylene (Teflon), or any other suitable material that is substantially liquid impermeable but allows for the diffusion of gases. Further exemplary elastomeric materials include poly-di-methyl-siloxane (PDMS). PDMS is a material commonly used to manufacture soft contact lenses. Additionally, the gas permeable housing 110 may comprise various combinations of one or more of these elastomeric materials, as well as additives designed to alter the color or refractivity of the material.

The gas permeable housing 110 can be generally rectangular in shape, as shown in FIG. 1. However, given the pliable nature of these gas permeable, elastomeric materials, the gas permeable housing 110 can be fabricated in virtually any shape and size. Housings that are shaped as square cubes, as well as irregularly shaped housing, or housing with curved or otherwise rounded edges can similarly be fabricated.

The gas permeable housing 110 can include a plurality of channels 114 and 116 each of which is independent in that fluid may not communicate between the different channels, as well as a plurality of ports 117. The gas permeable housing 110 comprising fluid channels 114 and vacuum channels 116 can be manufactured by pouring liquid polymer into a mold comprising structures that compliment fluid and vacuum channels. For example, liquid polymer can be mixed with a curing agent, typically in a 10:1 ratio by mass. The polymer mixture can then be poured onto the mold and heated. Heat enables the rapid cross-linking of the polymer. In a relatively short period of time, the polymer solidifies and the block of polymer (e.g. a gas permeable housing 110 of elastomeric material) can be peeled away from the mold. The block of polymer (the gas permeable housing 110) now contains, etched onto its surface, the pattern of channels 114 and 116 on the mold. The depths of the channels 114 and 116 etched into the housing will correspond to the heights of the channels on the surface of the mold. To manufacture a mold, a wafer is exposed to photolithography process involving alternating steps of cleaning, resist, baking, exposing, and developing to form a series of channels. These channels 114 and 116 may be of varying heights depending on the thickness of the wafer and the length and size of the channels. Exemplary heights range from approximately 2-20 μm. Particularly preferred heights are 5-15 μm.

Fluid channel 114 is the channel through which a sample will transit. The fluid channel 114 extends partially through the gas permeable housing and includes at least one dead-end 122. This dead-end 122 is separated from any other channel or port by some amount of gas permeable material. In FIG. 1, the fluid channel 114 is spaced away from the vacuum channel 116, and the dead-end 122 of the fluid channel 114 is separated from the vacuum channel 116 by gas permeable material 120. The spaced away channels are two passages (e.g. channels, ports, etc.) that are not contiguous with one another.

Fluid channels 114 and vacuum channels 116 can be of any of a variety of sizes, lengths, and shapes. By way of example, a fluid 114 or vacuum channel 116 may have a cross sectional area of approximately 100-900 square microns. Additionally, fluid channels 114 and vacuum channels 116 having a cross sectional area of less that 100 or greater than 900 square microns are also contemplated. The interior surface of the channel can have rounded surfaces or flat surfaces. Furthermore, the interior surfaces of the fluid channels 114 can be coated with one or more agents to decrease degradation of the sample or to decrease adherence of the sample to the surface of the fluid channel 114. Additionally, in a system containing both a fluid channel 114 and a vacuum channel 116, the invention contemplates that the fluid channel 114 and vacuum channel 116 can be the same size or can be different sizes. In certain embodiment, the vacuum channel 116 extends partially through the gas permeable housing 110 and contains at least one dead-end 122.

In certain embodiments, the gas permeable housing 110 has a plurality of fluid channels 114. Such plurality of fluid channels 114 may be arrayed in any of a number of configurations. Furthermore, when the housing 110 has both fluid channels 114 and vacuum channels 116, the fluid channels 114 and vacuum channels 116 may be arrayed in any of a number of configurations. For example, a plurality of fluid channels 114 may be arrayed in a series of equally spaced, parallel stripes of equal length and size. In embodiments where the housing 110 comprises both these plurality of fluid channels 114 and a plurality of vacuum channels 116, the vacuum channels 116 may be arrayed as a mirror image series of equally spaced, parallel stripes of equal length and size. Alternatively, the vacuum channels 116 may be arrayed as a series of equally spaced, parallel stripes of equal length and size that are interspersed between the fluid channels 114. In this embodiment, the gas permeable housing 110 comprises alternating, parallel stripes of fluid channels 114 and vacuum channels 116. These configurations are merely illustrative of the wide variety of configurations that can be readily designed and repeatedly manufactured.

Input ports 117 are passages through which samples are loaded into the fluid channels 114. FIG. 1 shows one configuration of input ports 117 which extend from the top of the housing 110 through the gas permeable material 120 and intersects with a fluid channel 114. In one embodiment, the input ports 117 and the openings 118 are formed as a single open passage there between. The input openings 118 intersect an outer surface of the gas permeable housing 110. In one embodiment, the input port 117 comprises an input well 119 and an input opening 118. The input opening 118 is that portion that meets an exterior surface of the gas permeable housing 110. The input well 119 is the remainder of the input port 117 that extends through the gas permeable housing 110 and intersects a fluid channel 114. Samples can be added at the input opening 118. Samples can be added using, for example, a needle (e.g. injecting, spotting), a pin, a pipettor, or any other suitable device.

Input ports 117 can be included in the gas permeable housing 110 during fabrication of the housing 110. Alternatively, input ports 117 can be added post-fabrication. In such embodiments, a gas permeable housing 110 comprising a fluid channel 114 and a vacuum channel 116 is further modified by penetrating the housing to form an input port 117. For example, a needle of a particular gauge can be used to puncture the gas permeable housing 110. The needle may be passed from the top of the housing 110 and through the housing 110, such that the needle intersects a fluid channel 114. Removal of the needle creates a recess which is an input port 117 such that the core of the gas permeable material 120 may be removed or a hole may be formed by puncture.

Formation of the input port 117 can occur as a step in the manufacturing process. For example, after fabrication of the gas permeable housing 110 comprising one or more of a fluid channel 114 and a vacuum channel 116, the gas permeable housing 110 can be aligned and placed beneath a robot or other machine that consecutively or simultaneously extends needles through the housing. The gas permeable housing 110 can be aligned with respect to this input port machine such that each input port 117 intersects one fluid channel 114. Alternatively, individual input ports 117 can be created, by hand, as a step in the manufacturing process. This embodiment may be advantageous for the manufacture of custom housings, or simple designs requiring one or a very small number of input ports. By way of another example, an input port 117 can be created by photolithography during manufacture of the gas permeable housing 110.

In another embodiment, formation of an input port 117 occurs post-manufacturing and is done by the end-user. For example, the end-user may purchase a gas permeable housing. Before using the housing 110, the end-user purchases or otherwise selects a needle, pin, or other similar tool for penetrating the housing and forming an input port 117, selects the appropriate configuration for the input port 117, and punctures the housing 110 to form an input port 117. In certain embodiments, the end-user purchases the gas permeable housing 110 and the means for forming an input port 117 as a kit from the manufacturer. In certain other embodiments, the end-user uses a robot or machine to consecutively or simultaneously extend needles through the housing 110 to form one or more input ports 117.

Input ports 117 can be of any of a number of sizes. A particularly preferred method for forming input ports is using needles or pins of varying gauges. Accordingly, the input port may have a diameter approximately equal to the inner diameter of a needle or pin of a particular gauge (e.g., 16, 18, 20, 22, 24, 26, 28 gauge needle).

Input ports 117 can be arrayed in any of a number of configurations, and a gas permeable housing 110 may comprise a single input port or a plurality of input ports 117. In the embodiment of the invention depicted in FIG. 1, the input port 117 extends from the top of the housing 110, such that the input opening 118 is at the top of the gas permeable housing 110. However, input ports can be configured such that the input opening 118, and thus sample loading, is on a side of the gas permeable housing 110. In certain embodiments, the gas permeable housing 110 comprises a plurality of fluid channels 114 and an equal number of input ports 117. In a particular configuration, each of the plurality of input ports 117 intersects a single fluid channel 114.

In certain embodiments, a substrate 112 is disposed beneath the gas permeable housing 110. The substrate 112 may be a slide, coverslip, filter, plate or microarray. The substrate 112 may be composed of, for example, glass, silica, plastic, or nitrocellulose. The gas permeable housing 110 may simply be placed on top of a surface of a substrate 112, such that the housing 110 and substrate 112 are held together only by gravity or only by gravity plus the pressure exerted at the vacuum port. Alternatively, the housing 110 and substrate 112 may be affixed using a clip or fastener, or using a sealant that helps adhere housing and substrate. Additionally, the gas permeable housing 110 may be baked to the substrate 112 to promote contact between the housing 110 and the substrate 112. Regardless of the method used to maintain contact between the housing 110 and the substrate 112, a substantially liquid impermeable seal is created between the housing 110 and the substrate 112. This prevents mixing of fluid samples between fluid channels 114.

In certain embodiments, the substrate 112 has one or more constituents affixed to a surface of the substrate 112. For example, a slide, coverslip, array, or filter may have one or more nucleic acid or amino acid-based probes affixed to a surface of the substrate 112. The constituents may have been deposited on the substrate 112 using the devices and methods of the invention, or the constituents may have been deposited and affixed using other methodologies.

The devices described in detail herein can be used to transfer liquid or gaseous samples, and the samples can be either hydrophobic or hydrophilic. Depending on the characteristics of the particular sample, one of skill in the art can select or modify the appropriate gas permeable material, channel number and configuration, port number and configuration, and pressure to most effectively transfer the sample.

Exemplary liquid samples include samples collected from human or non-human animals (e.g., blood, semen, plasma, cerebro-spinal fluid, saliva, urine). Furthermore, exemplary sample may be collected from plants, yeast, bacteria, or viruses. Regardless of the source of sample, particularly useful samples may comprises one or more constituents. Such constituents include, but are not limited to, DNA, RNA, amino acids, proteins, small organic molecules, small inorganic molecules, metals, antibodies, and the like. When the sample comprises such constituents, the remainder of the sample may comprise some sort of buffer or solvent in which the constituents are suspended or otherwise dissolved. These components of the sample may include water, oil, alcohol, medium, buffer, saline, detergent, and organic solvent.

Exemplary gaseous samples include comparatively heavy gases such as noble gases, organic or inorganic chemicals, industrial process chemicals, and airborne pathogens. Preferably, a gaseous sample should be sufficiently dense such that it can be transferred through the fluid channel via application of pressure faster than its rates of diffusion across the gas permeable materials that comprise the housing.

Regardless of the particular sample, it may sometimes be useful to label the sample to facilitate detection. For example, handling of samples may be facilitated by adding a visible label or dye to the sample. The visible dye should be inert, such that its presence provides color or contrast that assists the user without altering the biochemical properties of the sample. In one embodiment, each of a plurality of samples is labeled with a different visible dye to help distinguish among the samples. In another embodiment, each sample is labeled with the same dye which simply makes the sample easier to see.

In other embodiments, it may be useful to label a sample or to label constituents of the sample with a detectable label useful in detecting the sample or a constituent of the sample. For example, nucleic acids or proteins in a sample can be fluorescently labeled. These fluorescently labeled nucleic acids or proteins can now be detected using commercially available scanner to assess, for example, the interaction of the constituent of a sample with probes affixed to a substrate. Although fluorescent labeling is advantageous due to the ease of detecting fluorescently labeled species, other detectable labels are well known and can readily be used. For example, samples can be labeled with metals such as gold, samples can be labeled with labels detectable via a chromogenic reaction (e.g., alkaline phosphatase, biotin/strep, etc.), or samples can be radioactively labeled.

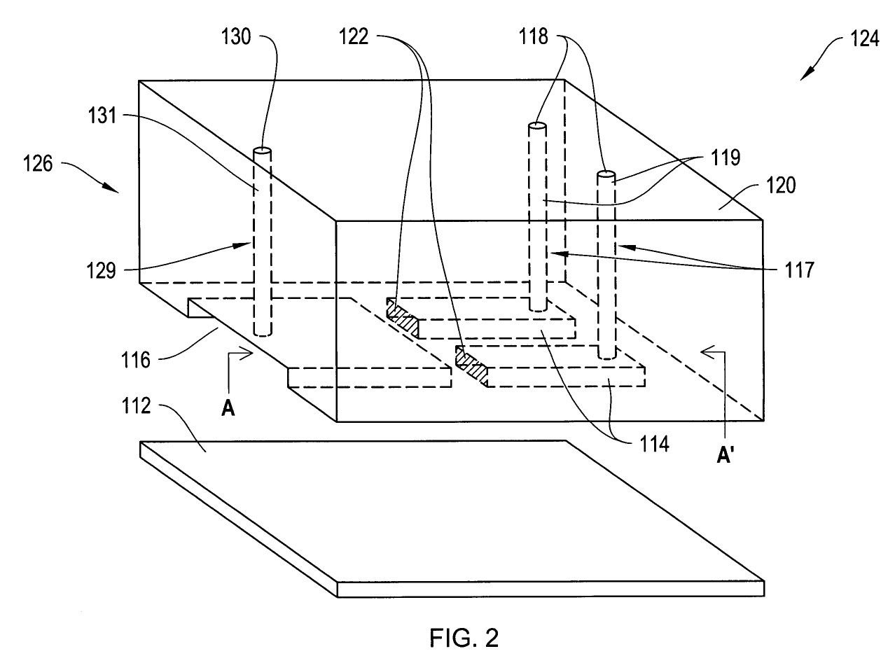

FIG. 2 depicts a three-dimensional view of another embodiment of a device to transfer fluids 124 comprising a gas permeable housing 126 attached to a substrate 112. The gas permeable housing 126 is formed from a gas permeable material 120 that is etched on one surface to form fluid channels 114 and a vacuum channel 116. A sample is introduced through input ports 118 and pressure is applied through the vacuum port 129. The input ports 117 comprise an input well 119 and an input opening 118. The vacuum port 129 comprises a vacuum well 131 and a vacuum opening 130. One end of the fluid channels 114 closer to the vacuum channel 116 forms a gas permeable dead-ends 122. Markers A and A′ are used to describe the location of cross-sectioning.

Similar to device 100 shown in FIG. 1, device 124 can be used to transfer a sample. In an exemplary illustrated embodiment, device 124 can be used to transfer a plurality of samples using one vacuum channel. In such embodiments, it may be cheaper and more convenient to manufacture the gas permeable housing 126 such that the housing 126 only comprises one or more fluid channels and one vacuum channel. Gas permeable housing 126 can be manufactured using the same technique as described for gas permeable housing 110 of FIG. 1. Samples can be added to the input ports 117 by injecting, pipetting, or otherwise adding samples at the input openings 118. Depending on the characteristics and volume of the particular sample, the permeability of the material in which the channel was constructed, and the amount of air trapped in the channel, all or a portion of a sample might flow through the input port 117 and along the channel 114. When multiple samples are analyzed, these samples often move at differing rates or a different percentage of each sample move along a channel 114. Therefore, this flow is unpredictable and uncontrollable, and reliance on this fluid flow alone would be inefficient and difficult to reproduce across multiple samples. Accordingly, to efficiently transfer a substantial amount of the sample from the input opening 118 to the fluid channel 114, pressure is applied, for example, via the vacuum port 129 and vacuum channel 116. The amount of pressure, as well as whether the pressure is negative or positive pressure, can be determined based on the characteristics of the sample. Application of pressure via the vacuum channel 116, by attaching a pressure source directly to the vacuum port 129, results in a pressure change in the vacuum channel 116, as well as a pressure change in the interior of the fluid channel 114. This pressure change in the fluid channel 114 transfers the sample through the input port and through the corresponding fluid channel 114 that intersects the input port. In one example, the sample is transferred to the dead-end 122 of the fluid channel 114. When analyzing multiple samples simultaneously, dead-ends 122 ensure that samples with differing flow rates are contained within the confines of the fluid channel and do not overflow. Thus, the use of dead-ends 122 in conjunction with a vacuum channel 116 and a vacuum port 129, permits more precise control of multiple samples being transferred and deposited on a substrate 112.

The vacuum channel 116 may be arranged in the gas permeable housing 126 such that one vacuum channel 116 may be used to remove the air from a plurality of fluid channels 114. Regardless of the particular combination of channels and ports, a vacuum port 129 is a passage through which pressure can be applied to the gas permeable housing 126. Specifically, pressure applied via the vacuum port 129 applies pressure to the interior of the fluid channel 114. This, in turn, transfers sample through the fluid channel 114. A vacuum port 129 extends from the exterior of the housing 126 and through the gas permeable material 120. The vacuum port 129 is spaced away from the fluid channel 114 (e.g., gas permeable material 120 separates a fluid channel 114 from a vacuum port 129). In embodiments where the gas permeable housing comprises both a vacuum port 129 and a vacuum channel 116, the vacuum port 129 may be spaced away from the vacuum channel 116 or the vacuum port 129 may intersect the vacuum channel 116.

In one embodiment, the vacuum port 129 comprises vacuum well 131 and a vacuum opening 130. The vacuum opening 130 is that portion that meets an exterior surface of the gas permeable housing 126. Pressure can be applied at the vacuum opening 130. The vacuum well 131 is the remainder of the vacuum port 129 that extends through the gas permeable housing 126.

Positive or negative pressure can be applied to the gas permeable housing 126 via the vacuum port 129. By way of illustration, a vacuum can be applied to the vacuum port 129 to exert a negative pressure. The particular pressure applied via the vacuum port 129, as well as whether the pressure is a positive or negative pressure, can be selected based on the physical characteristics of the sample, sample volume, fluid channel size, and the specific application of the device.

Vacuum ports 129 can be included in the gas permeable housing 126 during fabrication of the housing 126. Alternatively, vacuum ports 129 can be added post-fabrication. In such embodiments, a gas permeable housing 129 comprising a fluid channel 114 and/or a vacuum channel 116 is further modified by penetrating the housing 129 to form a vacuum port 129. For example, a needle of a particular gauge can be used to puncture the gas permeable housing 126. The needle may be passed from the top of the housing 126 and through the housing 126 such that the vacuum opening 130 is at the top of the housing 126. The needle may be passed from the bottom of the housing 126 and through the housing 126 such that the vacuum opening 130 is at the bottom of the housing 126. The needle can be positioned such that the vacuum port 129 is spaced away from a fluid channel 114 and spaced away from a vacuum channel 116. Furthermore, the needle can be positioned such that the needle is spaced away from a fluid channel 114 but intersects a vacuum channel 116. Removal of the needle creates a passage which is a vacuum port 129.

Formation of a vacuum port 129 can occur as a step in the manufacturing process. For example, after fabrication of the gas permeable housing 126 comprising one or more of a fluid channel 114 and/or vacuum channel 116, the gas permeable housing 126 can be aligned and placed beneath a robot or other machine that consecutively or simultaneously extends needles through the housing. The gas permeable housing 126 can be aligned with respect to this vacuum port machine such that a vacuum port 129 is spaced away from a fluid channel 114. Alternatively, a vacuum port 129 can be created, by hand, as a step in the manufacturing process. This embodiment may be advantageous for the manufacture of custom housings. By way of another example, a vacuum port 129 can be created by photolithography during manufacture of the gas permeable housing 126.

In another embodiment, formation of a vacuum port 129 occurs post-manufacturing and is done by the end-user. For example, the end-user may purchase a gas permeable housing 126. Before using the housing 126, the end-user purchases or otherwise selects a needle, pin, or other similar tool for penetrating the housing 126 and forming a vacuum port 129, selects the appropriate configuration for the vacuum port 129, and punctures the housing 126 to form a vacuum port 129. In certain embodiments, the end-user purchases the gas permeable housing 126 and the means for forming a vacuum port 129 as a kit from the manufacturer. In certain other embodiments, the end-user uses a robot or machine to consecutively or simultaneously extend needles through the housing 126 to form one or more vacuum ports 129.

Vacuum ports 129 can be of any of a number of sizes. A particularly preferred method for forming vacuum ports 129 is using needles or pins of varying gauges. Accordingly, the vacuum port 129 may have a diameter approximately equal to the inner diameter of a needle or pin of a gauge (e.g., 16, 18, 20, 22, 24, 26, 28 gauge needle).

A vacuum port 129 can be arrayed in any of a number of configurations, and a gas permeable housing 126 may comprise a single vacuum port 129 or a plurality of vacuum ports 129. In the embodiment of the invention depicted in FIG. 2, the vacuum port 129 extends from the top of the housing, such that the vacuum opening 130 is at the top of the gas permeable housing 126. However, vacuum ports 129 can be configured such that the vacuum opening 130 is on a side of the gas permeable housing 126 or beneath the gas permeable housing 126.

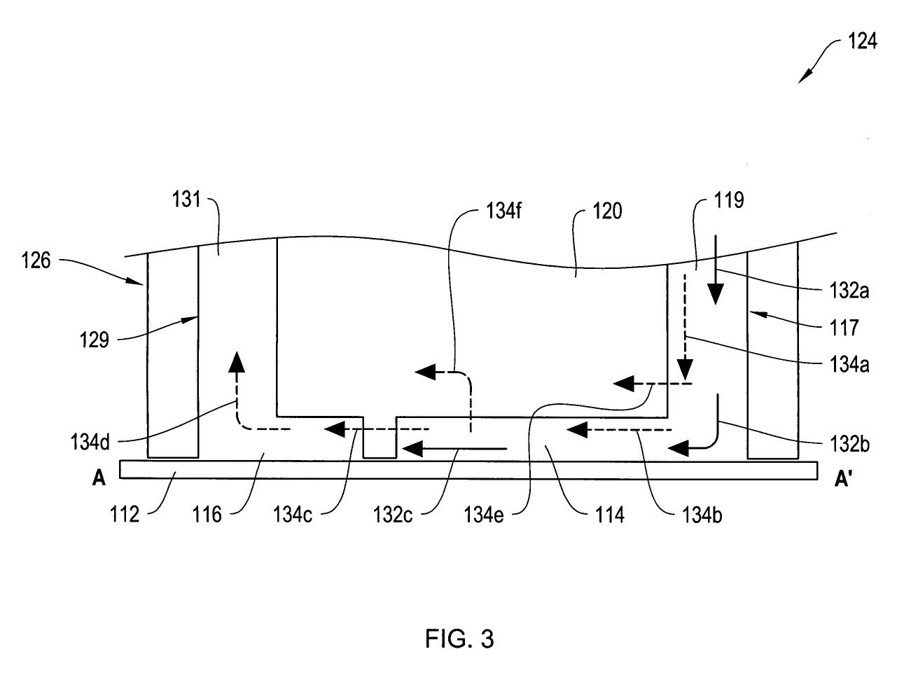

Transfer of fluid using device 124 can be seen in FIG. 3 which shows a cross-sectional side view of the assembled device 124 of FIG. 2. The device 124 includes a gas permeable element 120 etched with fluid channel 114 and vacuum channel 116. An input port 117 is included to introduce the sample and a vacuum port 129 is included to apply pressure to the interior of the vacuum channel 116 and the fluid channel 114. Solid arrows 132a-132c indicate the direction of sample movement and dashed arrows 134a-134f indicate the direction movement of air trapped in the channel. The etched gas permeable housing 126 is placed on top of the substrate 112. Cross-sectional markers A and A′ correspond to the markers A and A′ shown in FIG. 2.

Samples are introduced through the input opening 118 of the input port 117 as shown by arrow 132a. The fluid sample then flows through the input well 119 and enters the fluid channel 114 shown by arrow 132b. The sample is then transferred through the fluid channel 114 and stops at the gas permeable dead-end 122 shown by the arrow 132c. The sample moves through the fluid channel due to the applied negative pressure at the vacuum port 129. The applied negative pressure in the vacuum port 129 and the connected vacuum channel 116 causes a drop in pressure in the fluid channel 114. The pressure change in the fluid channel 114 transfers the sample to the dead-end 122. When negative pressure is applied in the vacuum port 129, air is transferred from the input port 117 along the direction of arrows 134a, through the fluid channel 114 along 134b, through the gas permeable dead-end 122 along 134c and out through the vacuum port 129 along 134d. Air can also be removed from the input port 117 and fluid channel 114 directly through the gas permeable material 120 as shown by arrows 134e and 134f. An applied pressure negative pressure in the fluid channel 114 and the vacuum channel 116 causes the housing 126 to be pulled against and seal to the substrate 112.

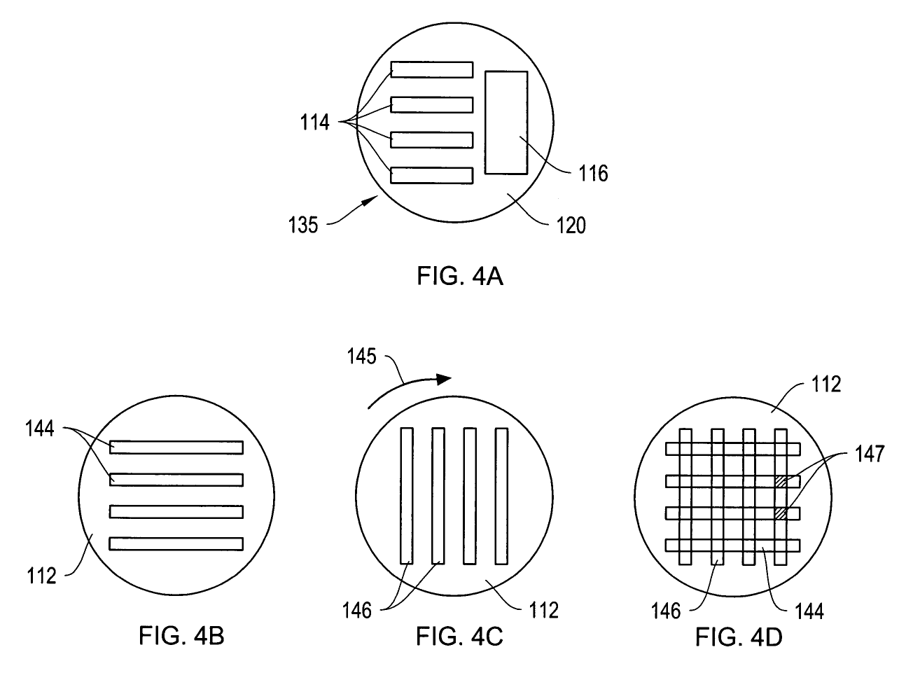

FIGS. 4A-4D depict a technique to analyze multiple samples simultaneously using one embodiment of the invention. FIG. 4A shows a bottom view of a gas permeable housing 135 including a gas permeable element 120 etched with fluid channels 114 and a vacuum channel 116. FIG. 4B shows experimental probes 144 deposited on the surface of a substrate 112 using the device 135 of FIG. 4A. FIG. 4C shows samples 146 deposited on top of the substrate 112 and probes 144 using the device 135 of FIG. 4A rotated in the direction of the arrow 145. FIG. 4D shows the arrangement of samples 146 orthogonally deposited on top of the probes 144 forming intersection regions 147.

In another embodiment of the invention, gas permeable housing 135 is cylindrically shaped and comprises a gas permeable material 120 etched on one surface to form fluid channels 114 and a vacuum channel 116. Using the gas permeable housing 135 of FIG. 4A, a plurality of probes 144 are first deposited in a series of parallel stripes on the substrate. These probes 144 could be at least one of nucleic acids, proteins, blood, hydrophilic substances and hydrophobic substances. The substrate 112 and the probes 144 are then, additionally and optionally, baked to attach the probes 144 onto the surface of the substrate 112. The probes 144 may include any sample as described for use with FIGS. 1 and 2.

The housing 135 can then be detached from the substrate and rotated such that the etched fluid channels 114 and vacuum channel 116 are perpendicular to the deposited probes 144. A plurality of desired test samples 146 are then deposited using the housing 135 onto the substrate 112 such that the probes 144 and samples 146 intersect each other at many places as shown in FIG. 4C. More specifically, each sample 146 intersects all the probes 144 at different locations along the length of the deposited sample 146. FIG. 4D shows these intersecting locations 147. Such a technique permits a user to analyze a plurality of samples 146 simultaneously by crisscrossing the samples with a specific choice of probes 144 and observing the response at intersecting locations 147. Control of the arrangement and configuration of samples 146 and probes 144 combined with speed and efficiency can be achieved using a gas permeable housing 135 of FIG. 4A having a dead-end and a applying a pressure differential.

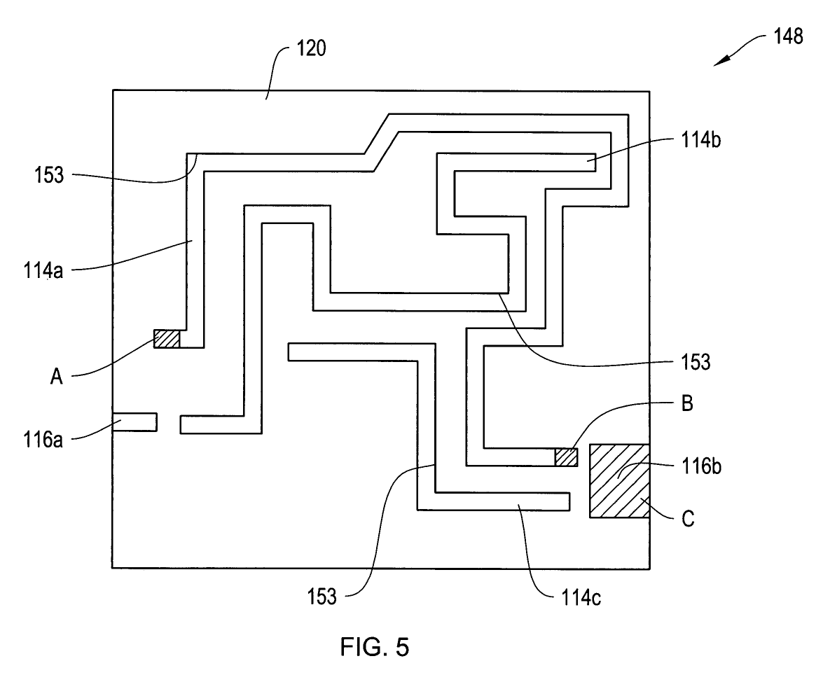

FIG. 5 shows a bottom view of another embodiment of the gas permeable housing 148 including multiple fluid channels 114a-114c and vacuum channels 116a and 116b etched on one surface of a gas permeable element 120 in a non-uniform and non-intersecting arrangement. Each fluid channel 114a-114c is coated on a plurality of sides with a gas impermeable material 153.

The gas permeable housing 148 shown in FIG. 5 is part of a device to transfer a sample from one location to another along a specified path on a substrate. Such a transfer can only be made possible if a differential pressure is applied along the specified path. Therefore, a plurality of side walls of the fluid channels 114a-114c are coated with gas-impermeable material 153. As an example, to move a sample from location A on the fluid channel 114a to location B using a vacuum applied at location C, all the side walls except for the dead-end at location B can be coated with gas-impermeable material. When a negative pressure is applied in the vacuum channel 116b at location C, the fluid channel 114a containing locations A and B is evacuated only through the dead-end at location B. This enables the transfer of the sample from location A to B along the path of the fluid channel 114a.

As discussed above, the invention provides efficient methods and systems that can be used to transfer samples on particular substrates. In one embodiment, the methods and systems described herein are used to actually make a useful substrate by depositing probes or other molecules of interest upon the substrate's surface. In another embodiment, the methods and systems described herein are used to transfer the sample to a substrate that has previously had probes or other molecules of interest deposit upon that substrate's surface. In still another embodiment, the methods and systems described herein are used both to make a particular substrate by depositing probes or other molecules upon the surface of the substrate and to transfer a sample to that substrate.

In one embodiment, each sample is transferred as a single line on a slide or other substrate using a single fluid channel. In other embodiments, multiple samples are transferred each as distinct lines using a plurality of distinct fluid channels. A particularly advantageous aspect of these distinct lines is that they are not in fluid contact with one another. Specifically, because the gas permeable housing is substantially liquid impermeable, as well as substantially impermeable to heavy gases such as noble gases, multiple fluid channels in the gas permeable housing are not in fluid contact with each other.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. A system for transferring a sample, comprising:
a substrate component, and
a gas permeable element being impermeable to the sample and arranged with the substrate component to define a fluid channel with a dead-end at an end of the fluid channel.

2. A system as in claim 1, wherein the gas permeable element comprises a gas permeable housing having patterns etched onto one surface, to define the fluid channel and the dead-end.

3. A system as in claim 2, wherein the gas permeable housing is placed in opposition to the substrate component.

4. The system as in claim 2, further comprising a fastener to affix the substrate component to the gas permeable housing.

5. The system as in claim 2, wherein the gas permeable housing further comprises at least one input port, which intersects the fluid channel and has an input landing for loading the sample.

6. The system as in claim 2, wherein a vacuum port and a vacuum channel are located within the gas permeable housing, and spaced away from the fluid channel, for applying a pressure to the interior of the fluid channel.

7. The system as in claim 1, wherein the fluid channel comprises an extended channel having the gas permeable element disposed therein to define the fluid channel and a vacuum channel.

8. The system as in claim 2, wherein at least one gas permeable housing wall of a fluid channel is coated with a gas impermeable material.

9. The system as in claim 2, wherein the gas permeable element is substantially liquid impermeable.

10. The system as in claim 2, wherein the gas permeable element comprises an essentially non-reactive elastomeric material.

11. The system as in claim 10, wherein the elastomeric material is selected from the group consisting of poly-di-methyl-siloxane (PDMS), polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), or polytetrafluoroethylene (Teflon).

12. The system as in claim 2, wherein the substrate component has at least one of nucleic acids, gold electrodes and proteins attached to a surface of the substrate component.

13. The system as in claim 2, wherein the substrate component includes one of a slide, microtiter plate, microarray a glass element, silica element and plastic element and a hybridization membrane.

14. The system as in claim 2, wherein the sample includes at least one of a liquid, gas, hydrophilic substances, hydrophobic substances, nucleic acids, proteins and blood.

15. A system as in claim 1, wherein the substrate component comprises a substrate having at least one channel etched onto a surface of the substrate.

16. A system as in claim 1, wherein the substrate component comprises a fluid passage extending at least partially through the substrate component and the gas permeable element being disposed in the fluid passage to form a gas permeable dead-end.

17. A system as in claim 16, wherein a gasket layer is placed in between the housing and the substrate along at least one fluid channel to form an airtight seal.

18. A method for transferring a sample, comprising:
(i) providing a system, comprising:
(a) at least one substrate component,
(b) at least one fluid channel,
(c) at least one gas permeable element which is impermeable to the sample and forms at least one dead-end,
(d) at least one input port, which intersects at least one fluid channel and comprises at least one input landing for loading at least one sample, and
(e) at least one vacuum port spaced away from at least one fluid channel for applying a pressure to the interior of at least one fluid channel;
(ii) adding the sample to the input landing of said system; and
(iii) applying pressure to the interior of the fluid channel by applying pressure at the vacuum port of said system;
wherein following application of the pressure at the vacuum port, the sample is transferred to the dead-end of the fluid channel.

19. The method as in claim 18, wherein the sample is at least one of liquid and gas and comprises at least one of hydrophilic substances, hydrophobic substances, nucleic acids, proteins, blood.

20. The method as in claim 18, wherein the applied pressure includes negative pressure and positive pressure.
